(19) United States
(12) Patent Application Publication
(10) Pub. No.: US 2022/0269656 A1
(43) Pub. Date: Aug. 25, 2022

(54) RESOURCE UNIT MANAGEMENT DATABASE AND SYSTEM FOR STORING AND MANAGING INFORMATION ABOUT INFORMATION TECHNOLOGY RESOURCES

(71) Applicant: HCL America Inc., Sunnyvale, CA (US)

(72) Inventor: Prafull Verma, Sunnyvale, CA (US)

(73) Assignee: HCL America Inc., Sunnyvale, CA (US)

(21) Appl. No.: 17/184,714

(22) Filed: Feb. 25, 2021

(51) Int. Cl. G06F 16/21; G06F 16/25; G06F 16/2457; G06F 16/22; G06F 9/50

(52) U.S. Cl. CPC G06F 16/214; G06F 16/252; G06F 16/24573; G06F 16/2282; G06F 9/5016

(57) ABSTRACT

Resource unit management database (RUMDB) and system for storing and managing information about information technology resources is disclosed. In an example, implementing an RUMDB includes defining a plurality of resource units (RUs) in an IT environment. A RU in the plurality of RUs is a tangible or an intangible entity that provides a measure of workload or efforts required to deliver and support IT services. The implementation further includes storing a set of general attributes identifying each of a plurality of RUs in a first data structure. The implementation further includes storing a set of specific attributes corresponding to attributes of each of the plurality of RUs, stored in the first data structure, in a second data structure that is separate from the first data structure.

### TECHNICAL FIELD

Generally, the invention relates to database management. More specifically, the invention relates to a resource unit management system for storing and managing information about Information Technology (IT) resources.

### BACKGROUND

Rapid advancement in the field of Information Technology (IT) attracts attention of many organizations for using IT to increase productivity and business effectiveness. For this, organizations using IT employ a wide range of techniques to store and manage the IT assets and “Configuration Items” (CIs) deployed in their environment. Many a times organizations also outsource the responsibility for maintaining their IT functions to a third-party managed services provider (MSP). These outsourced functions may be as basic as keeping IT equipment and other services functional all the way up to full IT team outsourcing. In most outsourcing contracts, billing of IT services is based on “Resource Units” (RUs). A Resource Unit is any tangible or intangible entity which provides a measurement of workload and efforts required to deliver and support services. All assets and CIs within the enterprise IT environment that are being managed by the MSP need to be associated with some RU in order to enable billing.

However, measurements of workloads and efforts sometimes get extremely difficult as parameters associated with an RU point to diversified data points that are spread across multiple data sources with ambiguous ownership. Therefore, the billing process of IT services becomes very tedious, cumbersome, and extremely labor-intensive. The billing process becomes worse as a Configuration Management Database (CMDB) is treated as primary data source for RU billing. This is because people performing the billing process fail to understand that the RU is fundamentally different from a Configuration Item (CI). Typically, people tend to confuse assets and CIs and are now adding the RU into this mix-up.

Therefore, there is a need of an efficient and structured database for storing and managing information about IT resources.

### SUMMARY OF INVENTION

In one embodiment, a resource management system for storing and managing information about Information Technology (IT) resources is disclosed. The resource management system may include a processor and a memory communicatively coupled to the processor. The memory may store processor-executable instructions, which, on execution, may cause the processor to implement a resource unit management database (RUMDB). For implementing the RUMDB, the processor-executable instructions, on execution, may further cause the processor to define a plurality of resource units (RUs) in an IT environment. It should be noted that, a RU in the plurality of RUs is a tangible or an intangible entity that provides a measure of workload or efforts required to deliver and support IT services. The processor-executable instructions, on execution, may further cause the processor to store a set of general attributes identifying each of a plurality of RUs in a first data structure. The processor-executable instructions, on execution, may further cause the processor to store a set of specific attributes corresponding to attributes of each of the plurality of RUs, stored in the first data structure, in a second data structure that is separate from the first data structure.

In another embodiment, a method of implementing a Resource Unit Management Database (RUMDB) for storing and managing information about Information Technology (IT) resources is disclosed. The method may include defining, by a resource management system, a plurality of resource units (RUs) in an IT environment. It should be noted that, a RU in the plurality of RUs is a tangible or an intangible entity that provides a measure of workload or efforts required to deliver and support IT services. The method may further include storing, by the resource management system, a set of general attributes identifying each of the plurality of RUs in a first data structure. The method may further include storing, by the resource management system, a set of specific attributes corresponding to attributes of each of the plurality of RUs, stored in the first data structure, in a second data structure that is separate from the first data structure.

In yet another embodiment, a non-transitory computer-readable medium storing computer-executable instruction storing a resource unit management database (RUMDB) for storing and managing information about Information Technology (IT) resources is disclosed. The RUMDB includes a first data structure configured to store a set of general attributes identifying each of a plurality of resource units (RUs) in an IT environment. An RU in the plurality of RUs is a tangible or an intangible entity that provides a measure of workload or efforts required to deliver and support IT services. The RUMDB further includes a second data structure separate from the first data structure and configured to store a set of specific attributes corresponding to attributes of each of the plurality of RUs in the first data structure. The first data structure and the second data structure are established to store a set of precise attributes corresponding to each of the plurality of resources.

It is to be understood that both the foregoing general description and the following detailed description are exemplary and explanatory only and are not restrictive of the invention, as claimed.

### BRIEF DESCRIPTION OF THE DRAWINGS

The present application can be best understood by reference to the following description taken in conjunction with the accompanying drawing figures, in which like parts may be referred to by like numerals

FIG. 1 is a block diagram of an exemplary system for implementing a Resource Unit Management Database (RUMDB) for storing and managing information about Information Technology (IT) resources, in accordance with some embodiments of the present disclosure.

FIG. 2 is a flow diagram of an exemplary process for implementing a RUMDB for storing and managing information about IT resources, in accordance with some embodiments of the present disclosure.

FIG. 3 is a flow diagram of an exemplary process for defining a plurality resource unit (RU) in an IT environment, in accordance with some embodiments of the present disclosure.

FIG. 4a is an exemplary representation of the set of general attributes stored in a first data structure is depicted via a table, in accordance with some embodiments of the present disclosure.

FIG. 4b an exemplary representation of the set of specific attributes stored in a second data structure is depicted via a table 400b, in accordance with some embodiments of the present disclosure.

FIG. 5a-5d an exemplary process of implementing a resource unit management database (RUMDB) is depicted via table, in accordance with some embodiment of the present disclosure.

FIG. 6a-6d depicts a database used for storing information associated with each of the plurality of RUs, in accordance with some embodiment of the present disclosure.

### DETAILED DESCRIPTION OF THE DRAWINGS

The following description is presented to enable a person of ordinary skill in the art to make and use the invention and is provided in the context of particular applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the invention is not intended to be limited to the embodiments shown, but is to be accorded the widest scope consistent with the principles and features disclosed herein.

While the invention is described in terms of particular examples and illustrative figures, those of ordinary skill in the art will recognize that the invention is not limited to the examples or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable storage media. Some other processes can be implemented using analog circuitry, as is well known to one of ordinary skill in the art. Additionally, memory or other storage, as well as communication components, may be employed in embodiments of the invention.

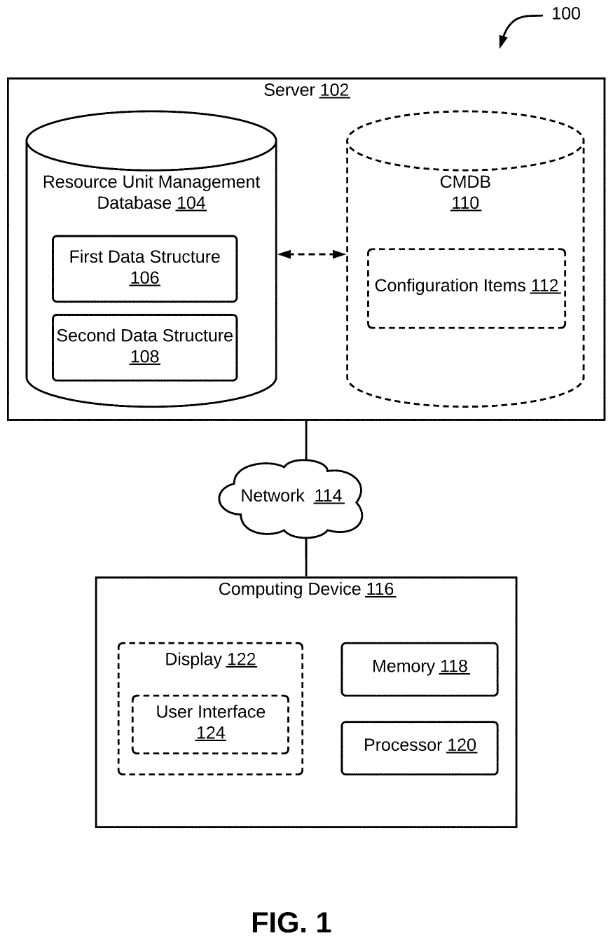

Referring now to FIG. 1, a block diagram of an exemplary system 100 for implementing a Resource Unit Management Database (RUMDB) 104 for storing and managing information about Information Technology (IT) resources is illustrated, in accordance with some embodiments of the present disclosure. In an embodiment, the exemplary system 100 may correspond to a resource management system. The resource management system may store and manage information about IT resources. In particular, the system 100 may include a server 102. The server 102 may include the RUMDB 104 for storing and managing information about IT resources. For this, the RUMDB 104 may include a first data structure 106 and a second data structure 108. In an embodiment, the first data structure 106 may be configured to store a set of general attributes for identifying each of a plurality of resource units (RUs) in an IT environment. An RU from the plurality of RUs may correspond to a tangible or an intangible entity that provides a measure of workload or efforts required to deliver and support IT services. Further, the second data structure 108 may be configured to store a set of specific attributes corresponding to attributes of each of the plurality of RUs in the first data structure 106. Moreover, the first data structure 106 and the second data structure 108 may be established to store a set of precise attributes corresponding to each of the plurality of RUs. As will be appreciated, the second data structure 108 may be separate from the first data structure 106. However, the second data structure 108 may be dependent on the first data structure 106.

In addition, the server 102 may include a Configuration Management Database (CMDB) 110. The CMDB 110 may be configured to receive and store a plurality of Configuration Items (CIs) 112. In an embodiment, the CMDB 110 may correspond to a plurality of sources required for identifying the plurality of RUs corresponding to a plurality of CIs 112. By way of an example, the plurality of sources other than CMDB 110, may include, but is not limited to, at least one of a manual channel, a directory service, a discovery tool, an event management tool, or a patching tool.

Further, the server 102 may be connected via a network 114 to a computing device 116. Moreover, the computing device 116 may fetch and process information related to various IT resources stored in the RUMDB 104 and the CMDB 110 of the server 102 via the network 114. The network 114, for example, may be any wired or wireless communication network and the examples may include, but may be not limited to, the Internet, Wireless Local Area Network (WLAN), Wi-Fi, Long Term Evolution (LTE), Worldwide Interoperability for Microwave Access (WiMAX), and General Packet Radio Service (GPRS). Examples of the computing device 116 may include but are not limited to, a desktop, a laptop, a notebook, a netbook, and a tablet.

The computing device 116 may include a memory 118, a processor 120, and a display 122. The display 122 may further include a user interface 124. A user or an administrator may interact with the computing device 116 and vice versa through the display 122 including the user interface 124. The display 122 may be used to display results (i.e., a golden dataset) based on actions performed by the computing device 116, to the user. In addition, the display 122 may be used to render a set of general attributes and a set of specific attributes to the user. The user interface 124 may be used by the user to provide inputs to the computing device 116. Thus, for example, in some embodiments, the computing device 116 may ingest user selection of the plurality of RUs in the IT environment. Further, for example, in some embodiment, the computing device 116 may render intermediate results (e.g., a validated dataset, and a normalized dataset) or final results (e.g., the golden dataset, and the plurality of RUs) to the user via user interface 124.

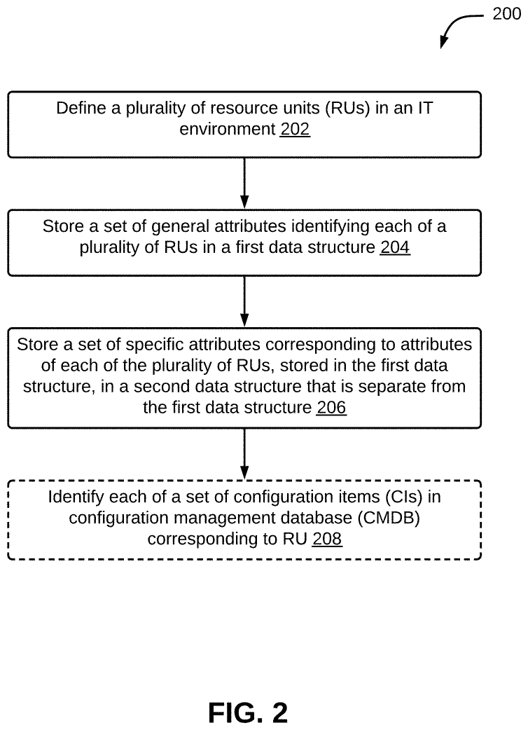

The memory 118 may store instructions that, when executed by the processor 120, may cause the processor 120 to implement the RUMDB 104 for storing and managing information about IT resources. The processor 120 may implement the RUMDB 104 by defining the plurality of RUs in the IT environment. In an embodiment, the processor 120 may create the first data structure 106 for storing the set of general attributes identified corresponding to each of the plurality of RUs. Further, the processor 120 may create the second data structure 108 for storing the set of specific attributes corresponding to attributes of each of the plurality of RUs, stored in the first data structure 106. As will be described in greater detail in conjunction with FIG. 2 to FIG. 5, in order to implement the RUMDB 104, the processor 120 in conjunction with the memory 118 may perform various functions including validation of a raw dataset, normalization of a validated dataset, aggregation of a normalized dataset, defining the plurality of RUs, creation of the first data structure 106, and creation of the second data structure 108.

The memory 118 also stores various data (e.g., a set of predefined rules, a normalized representation, etc.) that may be captured, processed, and/or required by the computing device 116. The memory 118 may be a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random Access Memory (DRAM), Static Random-Access memory (SRAM), etc.).

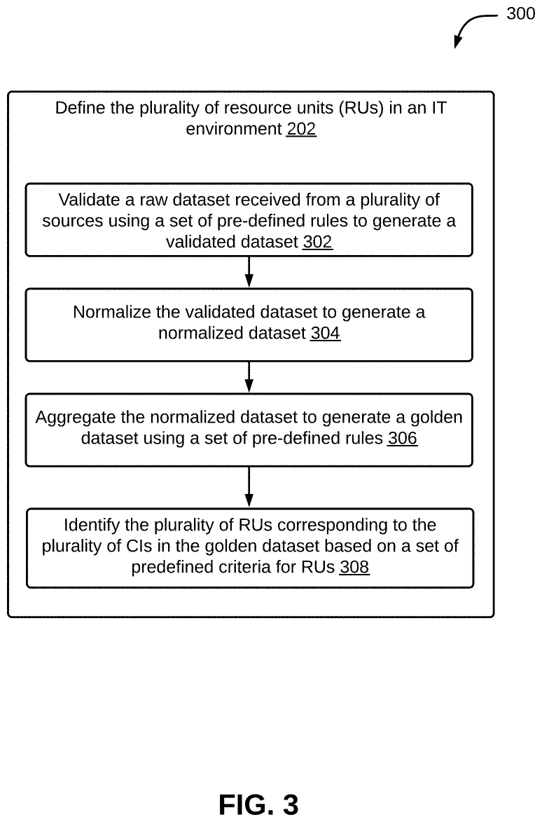

Referring now to FIG. 2 a flow diagram of an exemplary process 200 for implementing an RUMDB for storing and managing information about IT resources is depicted via flowchart, in accordance with some embodiments of the present disclosure. In reference to FIG. 1, the RUMDB may correspond to the RUMDB 104. In order to implement the RUMDB, at step 202, a plurality of RUs may be defined in an IT environment. In an embodiment, a RU in the plurality of RUs may be a tangible or an intangible entity that provides a measure of workload or efforts required to deliver and support IT services. This has been further explained in conjunction to FIG. 3. Once the plurality of RUs is defined, at step 204, a set of general attributes corresponding to each of the plurality of RUs may be generated and stored in a first data structure. In reference to FIG. 1, the first data structure may correspond to the first data structure 106. Moreover, the set of general attributes stored may be used to identify each of the plurality of RUs. The set of general attributes may include, but is not limited to, at least a primary key, a reference of RU name, a total number of RU executed, a total count based on billing entity, a job execution identification, a job execution time, a golden table name from which RUs are calculated, a RU status, or a latest executed result of RU.

Once the set of general attributes is stored in the first data structure, at step 206, a set of specific attributes corresponding to attributes of each of the plurality of RUs stored in the first data structure may be generated and stored in a second data structure. In reference to FIG. 1, the second data structure may correspond to the second data structure 108. In an embodiment, the second data structure may be separate from the first data structure. Moreover, the second data structure may be dependent on the first data structure. Further, the set of specific attributes stored in the second data structure may include, but is not limited to, at least one of a foreign key referring to the primary key, the primary key, names of one or more datasets from which a golden dataset is created after merging, a total count of the one or more datasets from which the golden dataset is created, or complete information of the golden dataset. In addition, in order to generate the set of general attributes and the set of specific attributes, at step 208, each of a set of configuration items (CIs) corresponding to each of the plurality of RUs may be identified from a plurality of configuration items (CIs) stored in configuration management database (CMDB). In reference to FIG. 1, the plurality of CIs may correspond to the configuration items 112 stored in the CMDB 110.

Referring now to FIG. 3 a flow diagram of an exemplary process 300 for defining a plurality resource unit (RU) in an IT environment is depicted via flowchart, in accordance with some embodiments of the present disclosure. In reference to FIG.2, in order to define the plurality of RUs as mentioned in step 202, a raw dataset may be received from a plurality of sources. The plurality of sources may include at least one of a CMDB, a manual channel, a directory service, a discovery tool, an event management tool, and a patching tool. In reference to FIG. 1 and FIG. 2, the CMDB may correspond to the CMDB 110. Thereafter, at step 302, the raw data set received from the plurality of sources may be validated to generate a validated dataset. In order to validate the raw dataset, one or more erroneous data records may be filtered out form the raw dataset. Moreover, the raw dataset may be validated based on a set of pre-defined rules.

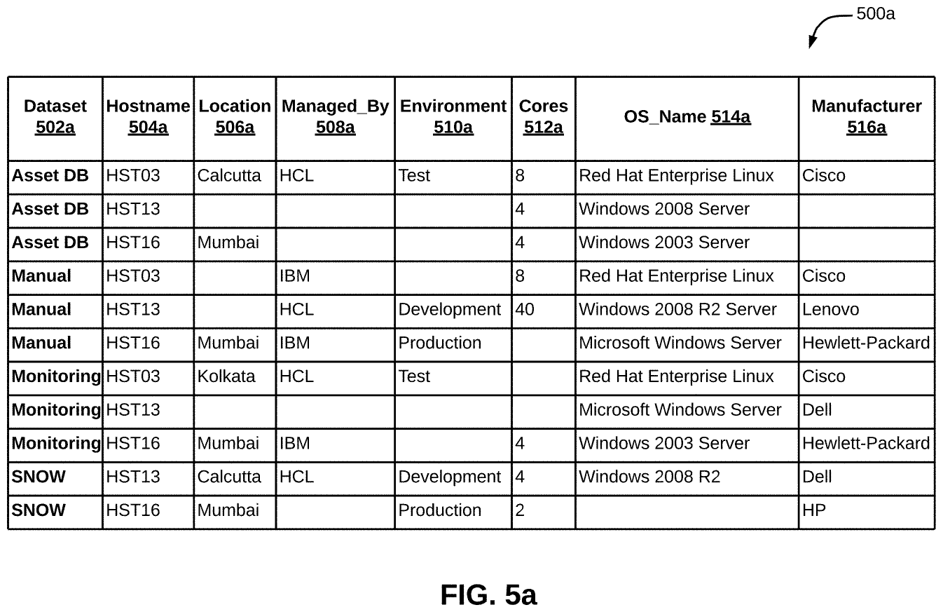

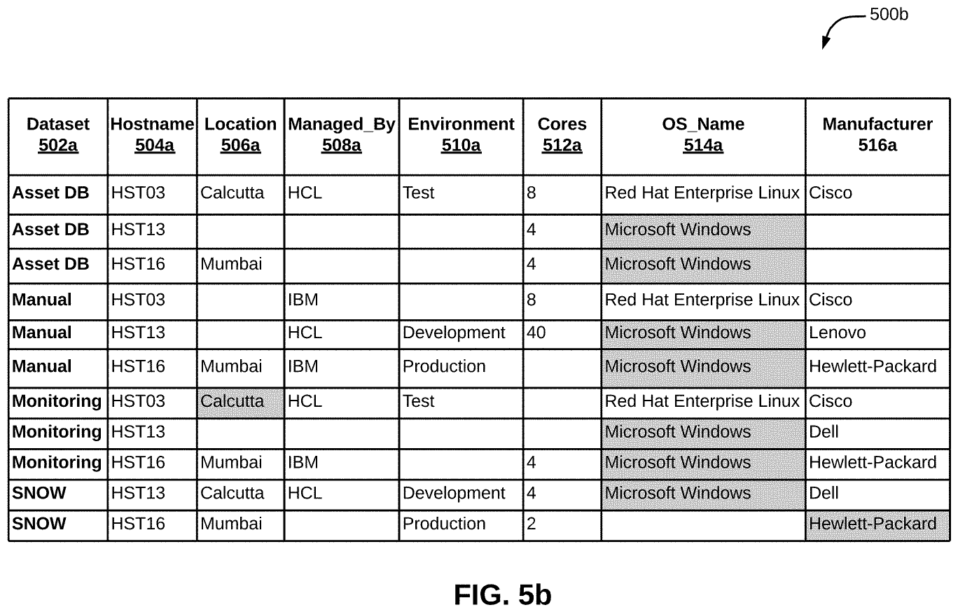

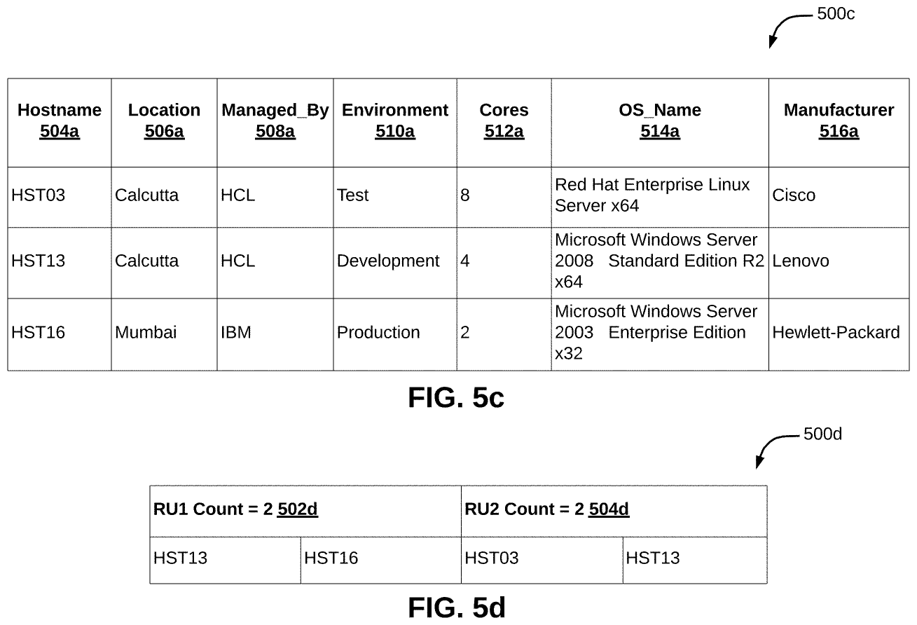

Once the validated dataset is generated, at step 304, the validated data set generated may be normalized to generate a normalized dataset. In an embodiment, for normalizing the validated dataset one or more representations of same data entity in the validated dataset may be replaced with a normalized representation. In other words, normalization of the validated dataset may correspond to replacement of the same data entity in the validated dataset with a standard value. Further, at step 306, the normalized dataset created may be aggregated based on a set of pre-defined rules to generate a golden record. In an embodiment, each of the set of pre-defined rules may be user defined. Moreover, aggregation of the normalized dataset may be done to create clean and accurate data records of the plurality of CIs received from the plurality of sources. As will be appreciated, the golden record generated may correspond to clean and accurate data records of the plurality of CIs. This has been further explained in detail in conjunction to FIGS. 5a-5d. Once the golden record is generated, at step 308, the plurality of RUs may be identified corresponding to the plurality of CIs in the golden dataset. In an embodiment, each of the plurality of CIs may be received from the plurality of sources. The plurality of sources may include at least one of a Configuration Management Database (CMDB), a manual channel, a directory service, a discovery tool, an event management tool, or a patching tool. In addition, each of the plurality of RUs may be identified based on a set of predefined criteria for RUs. In an embodiment, each of the set of predefined criteria for RUs may be defined by a service provider based on information received from the user. Moreover, the plurality of RUs may be defined to identify a set of billable service resource components. In an embodiment, the set of billable service resource components may correspond to any IT resource in an IT infrastructure that needs billing. The set of billable service resource components may be identified by pairing each of the set of billable service resource components with a correct RU from the plurality of RUs.

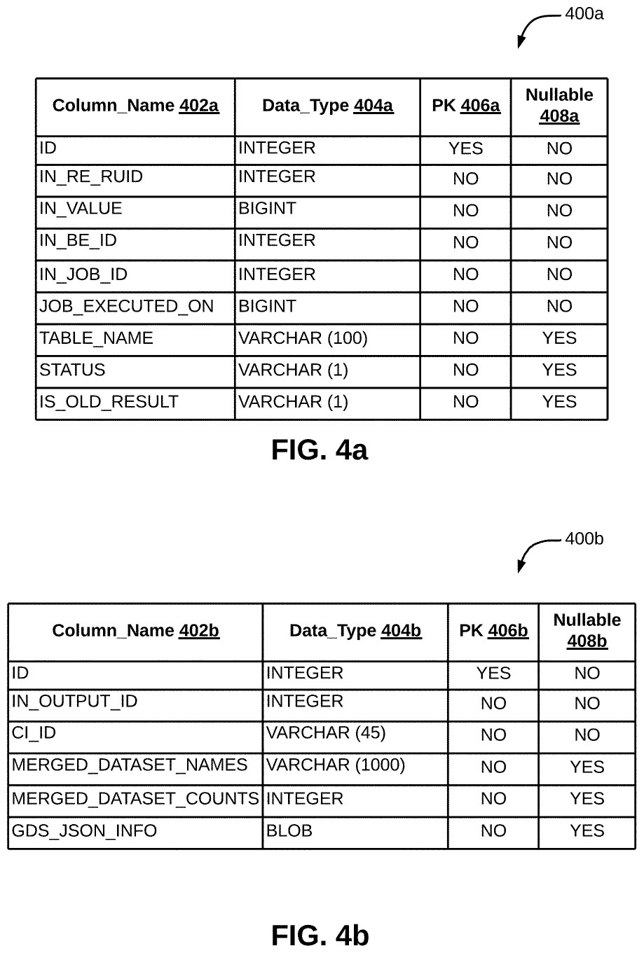

Referring now to FIG. 4a, an exemplary representation of the set of general attributes stored in a first data structure is depicted via a table 400a, in accordance with some embodiments of the present disclosure. In FIG. 4a, the table 400a may represents each of the set of general attributes. In reference to FIG. 1, the table 400a may represent each of the set of general attributes stored in the first data structure 106 of the RUMDB 104. The set of general attributes may include a primary key, a reference of RU name, a total number of RU executed, a total count based on billing entity, a job execution identification, a job execution time, a golden table name from which RUs are calculated, a RU status, or a latest executed result of RU.

By way of an example, in table 400a, each row of a column 402a represents the set of general attributes. For example, first row of the column 402a may represent the primary key depicted as “ID”. In an embodiment, the primary key may be automatically generated for each of the plurality of RUs. Second row of the column 402a may represent the reference of RU name depicted as “IN_RE_RUID”. Third row of the column 402a may represent the total number of RU executed depicted as “IN_VALUE”. In an embodiment, IN_VALUE may represent total resource count (i.e., workload or efforts required) for each of the set of billable service resource components. Moreover, each of the set of billable service resource components may correspond to the set of billable service resource components present in one of the plurality of RUs. In an embodiment, each of the set of billable service resource component may also be referred as a billing entity. Fourth row of the column 402a may represent a unique ID generated for each of the set of billable service resource components depicted as “IN_BE_ID”. Fifth row of the column 402a may represent the job execution identification depicted as “IN_JOB_ID”. Sixth row of the column 402a may represent job execution time as “JOB_EXECUTED_ON”. It should be noted that, the job execution time may be in EPOCH format. Seventh row of the column 402a may represent the golden table name from which RUs are calculated depicted as “TABLE_NAME”. Eighth row of the column 402a may represent the RU status depicted as “STATUS”. Lastly, ninth row of the column 402a may represent the latest executed result of RU depicted as “IN_OLD_RESULT”. In an embodiment, the latest executed results of RU may represent “Y” for latest calculated result of RU and “N” for previously calculated result of RU.

In addition, the table 400a may include a column i.e., a DATA_TYPE 404a. The DATA_TYPE 404a may represent a data type of each of the set of general attributes. Examples of the data types used for representing each of the set of general attributes may include but is not limited to, an integer (int), a big integer (bigint), and a variable character (varchar). Moreover, the table 400a may also include columns PK 406a and NULLABLE 408a for each of the set of general attributes. In an embodiment, the column PK 406a may represent whether each of the set of general attributes is a primary key or not. In addition, the column NULLABLE 408a may represent whether each of the set of general attributes accepts null value or not.

Referring now to FIG. 4b, an exemplary representation of the set of specific attributes stored in a second data structure is depicted via a table 400b, in accordance with some embodiments of the present disclosure. In reference to FIG. 1, the table 400b may represent each of the set of specific attributes stored in the second data structure 106 of the RUMDB 104. The set of specific attributes may include, but is not limited to, at least one of a foreign key referring to the primary key, the primary key, names of one or more datasets from which a golden dataset is created after merging, a total count of the one or more datasets from which the golden dataset is created, or complete information of the golden dataset. As will be appreciated, the second data structure may be separate from the first data structure. Moreover, the second data structure may be dependent on the first data structure. In other words, the second data structure may represent detailed information related to each of the plurality of RUs stored in the first data structure.

The table 400b may include a column name 402b, a data type 404b, a PK 406b and a nullable 408b. Each row of the column name 402b may represent each of the set of specific attributes. By way of an example, first row of the column 402b may represent the primary key depicted as “ID”. In an embodiment, the primary key may be automatically generated for each of the plurality of RUs. Second row of the column 402b may represent the foreign key referring to the primary key (i.e., the primary key of the first data structure) depicted as “IN_OUTPUT_ID”. Third row of the column 402b may represents an identification of each of the set of CIs depicted as “CI_ID”. In reference to FIG. 1, each of the set of CIs may correspond to the configuration items 112 stored in the CMDB 110. Fourth row of the column 402b may represent the names of one or more datasets from which the golden dataset is created after merging, depicted as “MERGED_DATASET_NAMES”. Fifth row of the column 402b may represent the total count of the one or more datasets from which the golden dataset is created, depicted as “MERGED_DATASET_COUNTS”. Lastly, sixth row of the column 402b may represent complete information of the golden dataset, depicted as “GDS_JSON_INFO”.

In addition, the table 400b may include a column i.e., a DATA_TYPE 404b. The DATA_TYPE 404b may represent a data type of each of the set of specific attributes. Examples of the data types used for representing each of the set of specific attributes may include but is not limited to, an integer, a varchar, and a blob. Moreover, the table 400b may also include columns PK 406b and NULLABLE 408b for each of the set of specific attributes. In an embodiment, the column PK 406b may represent whether each of the set of specific attributes is a primary key or not. In addition, the column NULLABLE 408b may represent whether each of the set of specific attributes accepts null value or not.

Referring now to FIG. 5a-5d, an exemplary process of implementing a resource unit management database (RUMDB) is depicted via table, in accordance with some embodiment of the present disclosure. In reference to FIG. 1, the RUMDB implemented may correspond to the RUMDB 104. A table 500a represents a sample dataset 502a received from four data sources comprising eleven records. The four data sources may include, but is not limited to Asset database, Manual, Monitoring & SNOW Discovery. In an embodiment, the four data sources may correspond to the plurality of data sources. The plurality of data sources may include, but is not limited to, at least one of the CMDB, a manual channel, a directory service, a discovery tool, an event management tool, or a patching tool. In reference to FIG, 1 the CMDB may correspond to the CMDB 110. Moreover, the sample dataset 502a may include information about three servers. The three servers may be uniquely identified based on hostname 504a, i.e., HST03, HST13, and HST16. It should be noted that, for ease of understanding the sample dataset 502a including eleven records is considered. However, a dataset with lakhs of records can be processed based on invention disclosed in the present disclosure. Further, the sample dataset 502a may include a location 506a, managed_by 508a (a variable indicating a managing entity associated with the hostname 504a), environment 510a, a number of cores 512a, OS_name 514a, and a manufacturer 516a.

In an embodiment, initially, a raw dataset may be received. The raw data set may first be validated based on the set of pre-defined rules to generate the sample dataset 502a. In order to validate the raw dataset, one or more erroneous data records present in the raw dataset may first be filtered out. In other words, a data validation may be performed for the raw dataset to eliminate NULL values, junk values, and special characters based on the set of pre-defined rules. In reference to FIG. 1, the sample dataset 502a received (as depicted by the table 500a) may be processed by the computing device 116 of the resource management system 100 to define the plurality of RUs.

The computing device 116 may thereafter normalize the sample dataset 502a received. The sample dataset 502a received may be normalized in order to generate a normalized dataset. For normalizing the sample dataset, the computing device 116 may replace one or more representations of same data entity present in the sample dataset 502a with a normalized representation. The normalized dataset generated from the sample dataset 502a is depicted via a table 500b. In table 500b, column with grey color represents same data entity present in the sample dataset 502a. In an embodiment, the sample data may be normalized to generated homogenous dataset for consistent reporting.

Upon generating the normalized dataset, the normalized dataset may be aggregated to generate a golden dataset based on the set of pre-defined rules. Moreover, the normalized dataset may be aggregated to create clean and accurate data records of the plurality of CIs. The clean and accurate data records created may correspond to a dataset with one unique record at a time. The golden dataset generated may be represented as a table 500c depicted in FIG. 5c. In addition, the aggregation of the normalized dataset may be performed based on priority of data records received from the four datasets. In the table 500c, the priority of data records received may be in a sequence comprising SNOW Discovery, Monitoring, Asset database, and Manual. It should be noted that, the priority of the data records may be configurable. In other words, the priority of the data records may define based on at least one of a requirement of a customer and an assessment of data experts working with the data records.

Once the golden dataset is generated, a set of general attributes and a set of specific attributes may be identified from the golden dataset. The set of general attributes may include a primary key, a reference of RU name, a total number of RU executed, a total count based on billing entity, a job execution identification, a job execution time, a golden table name from which RUs are calculated, a RU status, or a latest executed result of RU. In addition, the set of specific attributes may include at least one of a foreign key referring to the primary key, the primary key, names of one or more datasets from which a golden dataset is created after merging, a total count of the one or more datasets from which the golden dataset is created, or complete information of the golden dataset. In an embodiment, once the golden dataset is generated, the plurality of CIs may be categorized into at least one of the plurality of RUs, as per a set of predefined criteria for a given application. Moreover, each of the plurality of RUs may be defined based on contractual agreement between a customer and a service provider. Further, in the table 500c, the primary key may correspond to a plurality of hostname as depicted by column hostname 504a of the table 500a. Thereafter, once the set of general attributes and the set of specific attributes is identified from the golden dataset generated, a plurality of RUs may be defined corresponding to each data entity of the golden dataset. The plurality of resource units may be defined based on requirement of a customer. FIG. 5d, represents the plurality of RUs defined for the golden dataset generated, depicted via table 500d. The table 500d represents two RUs, i.e., RU1 (count=2) 502d, and RU2 (count=21) 504d, defined for the golden dataset. In an embodiment, a first set of CIs from the plurality of CIs of the golden records may be categorized into RU1, when each of the first set of CIs satisfies criteria of RU1. By way of an example, the first set of CIs of the golden dataset may be categorized in RU1, based on following condition: RU1: OS_Name=Microsoft Windows AND Environment=Production. Similarly, a second set of CIs from the plurality of CIs may be categorized in RU2, based on following condition: RU2: Environment # Product OR Managed_By=HCL. In other words, all CIs or records in 500c that satisfy criteria of RU1 or RU2 will lie in that corresponding resource unit. As will be appreciated, though not desirable, one CI may be part of more than one RU. By way of an example, as depicted in table 500d, HST13 is a part of both RUs, i.e., RU1 and RU2. This happens usually when the resource units are not defined properly or correctly. Thus, such CIs may be easily identified and reported so as to correct the definition of the resource unit. Such correction ensures that a CI belong to one RU only. In reference to FIG. 1, the set of general attributes and the set of specific attributes identified from the golden dataset may be stored in the first data structure 106 and the second data structure 108 of the RUMBD 104.

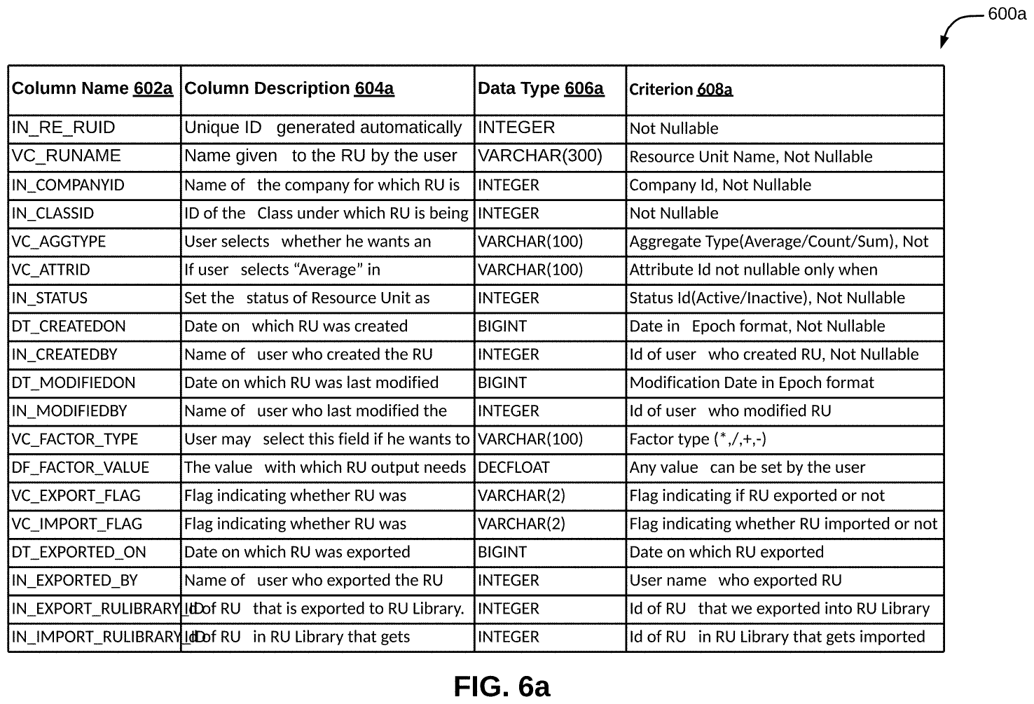

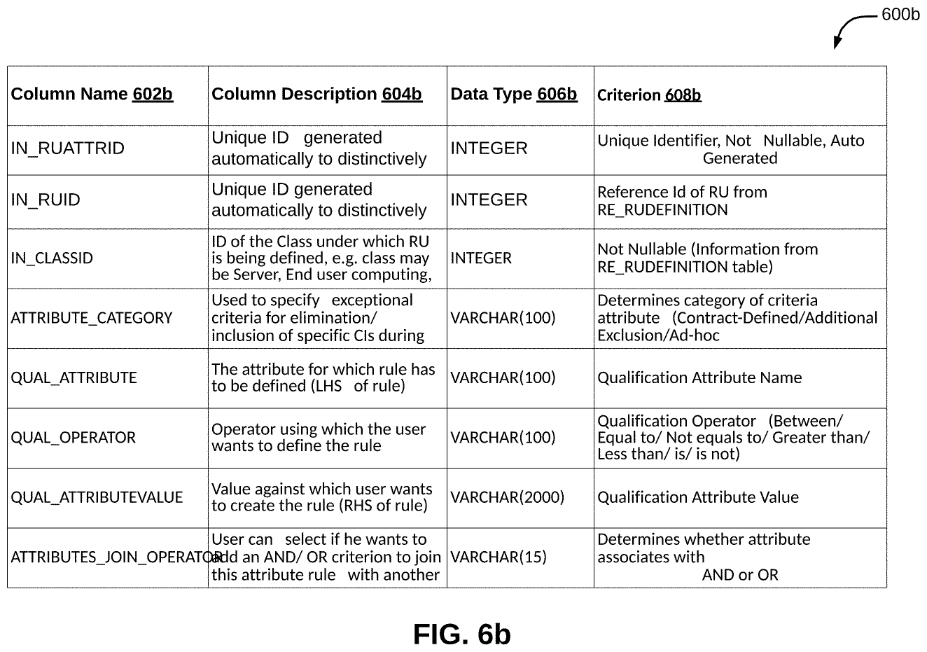

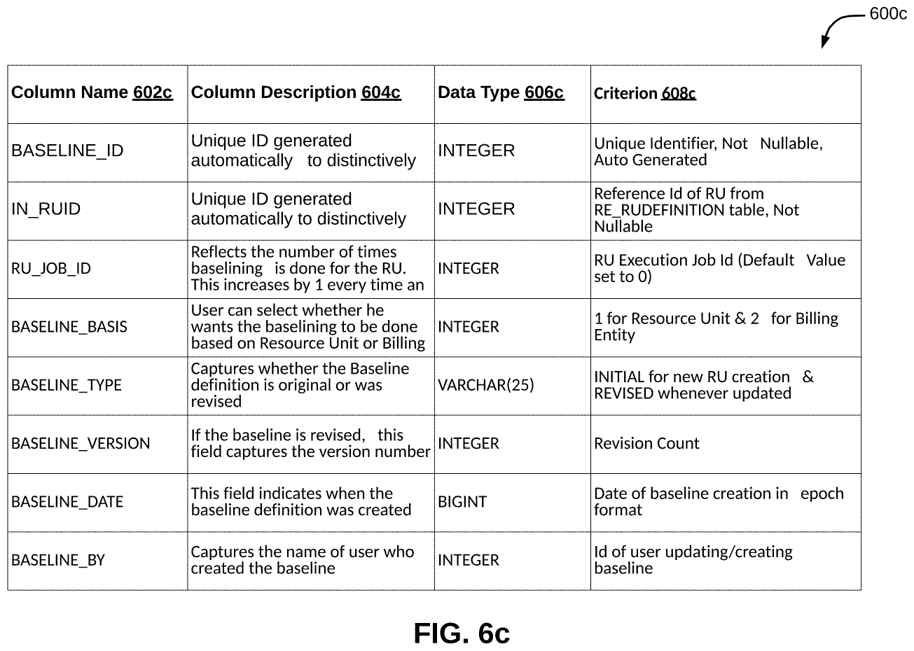

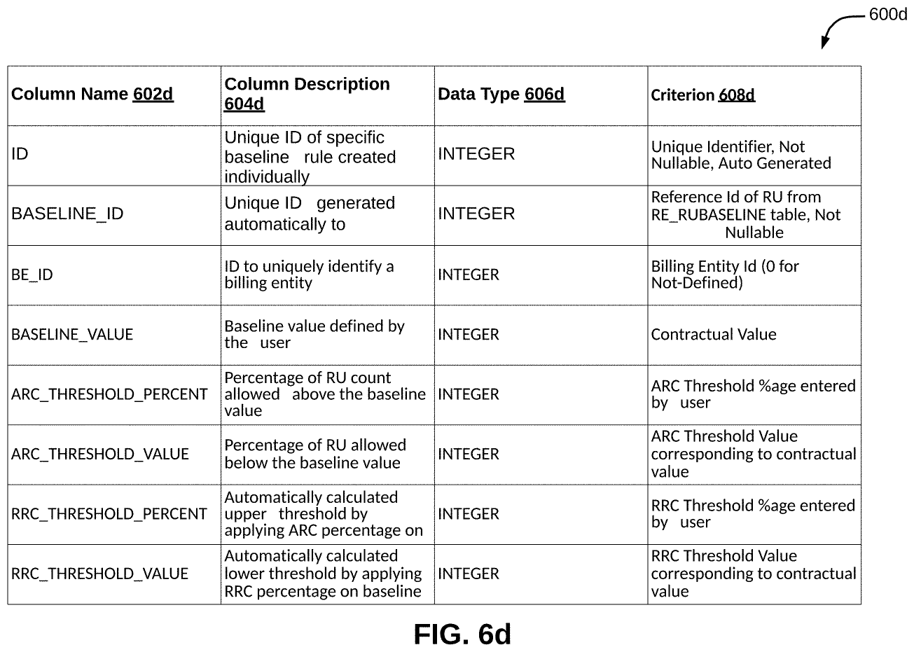

Referring now to FIG. 6a-6d, a database used for storing information associated with each of the plurality of RUs is depicted via tables, in accordance with some embodiment of the present disclosure. The database as depicted in present FIG. 6a-6d comprises a set of four tables. In an embodiment, first table from the set of four tables may correspond to RE_RUDEFINITION as depicted via table 600a in FIG. 6a. The table 600a, i.e., the RE_RUDEFINITION may store all high-level details of each of the plurality of RUs. As will be appreciated, the table 600a may include all high-level details except criteria and baseline of each of the plurality of RUs. Additionally, the table 600a may have some columns related to information associated with each of the plurality of RUs. It should be noted that, the associated information may be imported from a customer (also referred as user) of the RUMDB. In addition, when the information associated with each of the plurality of RUs is already present in the RUMDB, then the associated information may be exported or downloaded by the user. In reference to FIG. 1, the RUMDB may correspond to the RUMDB 104.

The table 600a may include a column name 602a, a column description 604a, a data type 606a, and a criteria 608a. The column name 602a may represent name of each of a first set of parameters associated with each of the plurality of RUs. In an embodiment, the first set of parameters may correspond to the set of general attributes associated with each of the plurality of RUs. The column description 604a may represent description of name provided to each of the first set of parameters. The datatype 606a may represent datatype associated with each of the first set of parameters. The criteria 608a may define criteria for providing values associated with each of the first set of parameters.

By way of an example, as depicted in table 600a, for ‘IN_RE_RUID’ of the column name 602a, the column description 604a may be “unique ID generated automatically to distinctively identify an RU”. The datatype 606a for ‘IN_RE_RUID’ may be integer. In addition, the criteria 608a for ‘IN_RE_RUID’ may be not-nullable. It should be noted that, ‘IN_RE_RUID’ may be not-nullable as the unique ID that may be generated cannot be a null value.

In an embodiment, second table from the set of four tables may correspond to RE_RUDEFINITIONATTRIBUTE as depicted via table 600b in FIG. 6b. The table 600b may store criteria attributes details associated with each of the plurality of RUs. The table 600b may store criteria attributes details based on one-to-many mapping from table 600a, i.e., RE_RUDEFINITION.

The table 600b may include a column name 602b, a column description 604b, a data type 606b, and a criteria 608b. The column name 602b may represent name of each of a second set of parameters associated with each of the plurality of RUs. In an embodiment, the second set of parameters may correspond to the set of specific attributes associated with each of the plurality of RUs. The column description 604b may represent description of name provided to each of the second set of parameters. The datatype 606b may represent datatype associated with each of the second set of parameters. The criteria 608b may define criteria for providing values associated with each of the second set of parameters.

By way of an example, as depicted in table 600b, for ‘IN_RUATTRID’ of the column name 602b, the column description 604b may be “unique ID generated automatically to distinctively identify an RU rule”. The datatype 606b for ‘IN_RUATTRID’ may be integer. In addition, the criteria 608b for ‘IN_RUATTRID’ may be unique identifier, not-nullable, and auto-generated. It should be noted that, ‘IN_RUATTRID’ may be not-nullable as the unique ID that may be generated cannot be a null value.

In an embodiment, third table from the set of four tables may correspond to RE_RUBASELINE as depicted via table 600c in FIG. 6c. The table 600c may store high level baseline details associated with each of the plurality of RUs. The table 600c may store high level baseline details with one-to-many mapping from table 600a, i.e., RE_RUDEFINITION to table 600c. In addition, the table 600c may store details for multiple revisions done to same baseline.

The table 600c i.e., the RUBASELINE may provide variance of the RU count (i.e., count of CIs within RU) from its baseline defined in the table 600a, i.e., RE_RUDEFINITION. In an embodiment, when the RU count may be more than a defined baseline, then the RU count may be shown into ARC (Additional resource count). In addition, when the RU count may be less than the defined baseline, then the RU count may be shown in to RRC (Reduced Resource Count). A value of the RU count determined may be utilized to access probable cause of variance from an expected count. In addition, the value of the RU count determined may be utilized to perform billing of customer differently, when the RU count goes beyond variance limit.

In an embodiment, the baseline may be defined in two ways. First way may include defining of baseline based on RU. In order to define the baseline based on RU, a baseline may be defined for each of a particular RU. Moreover, when the baseline is defined via first way, then if a count of CIs is above or below a specific count for particular RU may be highlighted. Further, second way may include defining the baseline based on billing entity. In an embodiment, the billing entity may correspond to an entity that is charged for the CIs. Moreover, when the baseline is defined via second way, then if the count of CIs assigned to a Billing Entity goes beyond the threshold may be captured.

The table 600c may include a column name 602c, a column description 604c, a data type 606c, and a criteria 608c. The column name 602c may represent name of each of a third set of parameters associated with each of the plurality of RUs. The column description 604c may represent description of name provided to each of the third set of parameters. The datatype 606c may represent datatype associated with each of the third set of parameters. The criteria 608c may define criteria for providing values associated with each of the third set of parameters.

By way of an example, as depicted in table 600c, for ‘BASELINE_ID’ of the column name 602c, the column description 604c may be “unique ID generated automatically to distinctively identify a baseline definition”. The datatype 606c for ‘BASELINE_ID’ may be integer. In addition, the criteria 608c for ‘BASELINE_ID’ may be unique identifier, not-nullable, and auto-generated. It should be noted that, ‘IN RUATTRID’ may be not-nullable as the unique ID that may be generated cannot be a null value.

In an embodiment, fourth table from the set of four tables may correspond to RE_RUBASELINE_DETAILS as depicted via table 600d in FIG. 6d. The table 600d may store finer baseline details for each of the plurality of RUs. Moreover, the finer baseline details may be stored in table 600d with one-to-many mapping from the table 600c, i.e., the RE_RUBASELINE. In present FIG. 6d, the table 600d may include a column name 602d, a column description 604d, a data type 606d, and a criteria 608d. The column name 602d may represent name of each of a fourth set of parameters associated with each of the plurality of RUs. The column description 604d may represent description of name provided to each of the fourth set of parameters. The datatype 606d may represent datatype associated with each of the fourth set of parameters. The criteria 608d may define criteria for providing values associated with each of the fourth set of parameters.

By way of an example, as depicted in table 600d, for ‘ID’ of the column name 602d, the column description 604d may be “unique ID of specific baseline rule created individually”. The datatype 606d for ‘ID’ may be integer. In addition, the criteria 608d for ‘ID’ may be unique identifier, not-nullable, and auto-generated. It should be noted that, ‘IN_RUATTRID’ may be not-nullable as the unique ID that may be generated cannot be a null value.

Various embodiments provide method and system for implementing a resource unit management database (RUMDB). In particular, the disclosed method and system, described in various embodiments discussed above, may allow the user of the resource management system to identify the set of billable service resource components in the IT environment by pairing each of the set of billable service resource components with a correct RU from the plurality of RUs.

In some embodiments, the disclosed method and system may help to define a plurality of resource units (RUs) in an IT environment. Further, the disclosed method and system may store a set of general attributes identifying each of the plurality of RUs in a first data structure. Thereafter, the disclosed method and system may store a set of specific attributes corresponding to attributes of each of the plurality of RUs, stored in the first data structure, in a second data structure that is separate from the first data structure.

The disclosed method and system provide some advantages like a reliable, organized and consistent mechanism for identifying various billable service components in an IT environment which is more accurate and comprehensive than traditional CI inventory count. The disclosed method and the system are more accurate and comprehensive because they merge details of same CIs received from multiple sources, thereby providing more confidence to the user for data records. In addition, the disclosed method and system may support higher contribution of data source tools for billing consolidation of billable service components as compared to that of traditional CI inventory. Further, the disclosed method and system may provide effective and standardized process for tracking resource unit for correct billing of various billable service components of the IT environment.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or process steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A resource management system for storing and managing information about Information Technology (IT) resources, the resource management system comprising:
a processor; and
a memory communicatively coupled to the processor, wherein the processor and the memory are configured for executing an implementation of a resource unit management database (RUMDB) by:
defining a plurality of resource units (RUs) in an IT environment, wherein a RU in the plurality of RUs is a tangible or an intangible entity that provides a measure of workload or efforts required to deliver and support IT services;
storing a set of general attributes identifying each of a plurality of RUs in a first data structure; and
storing a set of specific attributes corresponding to attributes of each of the plurality of RUs, stored in the first data structure, in a second data structure that is separate from the first data structure.

2. The resource management system of claim 1, wherein the set of general attributes comprises at least a primary key, a reference of RU name, a total number of RU executed, a total count based on billing entity, a job execution identification, a job execution time, a golden table name from which RUs are calculated, a RU status, or a latest executed result of RU.

3. The resource management system of claim 2, wherein the set of specific attributes comprises at least one of a foreign key referring to the primary key, the primary key, names of one or more datasets from which a golden dataset is created after merging, a total count of the one or more datasets from which the golden dataset is created, or complete information of the golden dataset.

4. The resource management system of claim 3, wherein the set of specific attributes comprises an identification of each of a set of configuration items (CIs) in configuration management database (CMDB) corresponding to RU.

5. The resource management system of claim 1, wherein defining the plurality of RUs comprises identifying the plurality of RUs corresponding to a plurality of CIs received from a plurality of sources, and wherein the plurality of sources comprises at least one of a CMDB, a manual channel, a directory service, a discovery tool, an event management tool, or a patching tool.

6. The resource management system of claim 5, wherein defining the plurality of RUs comprises:
validating a raw dataset received from the plurality of sources using a set of pre-defined rules to generate a validated dataset, wherein validation comprises filtering-out one or more erroneous data records in the raw dataset;
normalizing the validated dataset to generate a normalized dataset, wherein normalization comprises replacing one or more representations of same data entity in the data records with a normalized representation;
aggregating the normalized dataset to generate a golden dataset using a set of pre-defined rules, wherein aggregation comprises creating clean and accurate data records of the plurality of CIs; and
identifying the plurality of RUs corresponding to the plurality of CIs in the golden dataset based on a set of predefined criteria for RUs.

7. The resource management system of claim 5, wherein the RUMDB is implemented for IT resource billing, and wherein defining the plurality of RUs comprises:
identifying a set of billable service resource components by pairing each of the set of billable service resource components with a correct RU from the plurality of RUs.

8. A method of implementing a Resource Unit Management Database (RUMDB) for storing and managing information about Information Technology (IT) resources, the method comprising:
defining, by a resource management system, a plurality of resource units (RUs) in an IT environment, wherein a RU in the plurality of RUs is a tangible or an intangible entity that provides a measure of workload or efforts required to deliver and support IT services;
storing, by the resource management system, a set of general attributes identifying each of the plurality of RUs in a first data structure; and
storing, by the resource management system, a set of specific attributes corresponding to attributes of each of the plurality of RUs, stored in the first data structure, in a second data structure that is separate from the first data structure.

9. The method of claim 8, wherein the set of general attributes comprises at least a primary key, a reference of RU name, a total number of RU executed, a total count based on billing entity, a job execution identification, a job execution time, a golden table name from which RUs are calculated, a RU status, or a latest executed result of RU.

10. The method of claim 9, wherein the set of specific attributes comprises at least one of a foreign key referring to the primary key, the primary key, names of one or more datasets from which a golden dataset is created after merging, a total count of the one or more datasets from which the golden dataset is created, or complete information of the golden dataset.

11. The method of claim 10, wherein the set of specific attributes comprises an identification of each of a set of configuration items (CIs) in configuration management database (CMDB) corresponding to RU.

12. The method of claim 8, wherein defining the plurality of RUs comprises identifying the plurality of RUs corresponding to a plurality of configuration items (CIs) received from a plurality of sources, and wherein the plurality of sources comprises at least one of a Configuration Management Database (CMDB), a manual channel, a directory service, a discovery tool, an event management tool, or a patching tool.

13. The method of claim 12, wherein defining the plurality of RUs comprises:
validating a raw dataset received from the plurality of sources using a set of pre-defined rules to generate a validated dataset, wherein validation comprises filtering-out one or more erroneous data records in the raw dataset;
normalizing the validated dataset to generate a normalized dataset, wherein normalization comprises replacing one or more representations of same data entity in the data records with a normalized representation;
aggregating the normalized dataset to generate a golden dataset using a set of pre-defined rules, wherein aggregation comprises creating clean and accurate data records of the plurality of CIs; and
identifying the plurality of RUs corresponding to the plurality of CIs in the golden dataset based on a set of predefined criteria for RUs.

14. The method of claim 12, wherein the RUMDB is implemented for IT resource billing, and wherein defining the plurality of RUs comprises:
identifying a set of billable service resource components by pairing each of the set of billable service resource components with a correct RU from the plurality of RUs.

15. A non-transitory computer-readable medium storing a resource unit management database (RUMDB) for storing and managing information about Information Technology (IT) resources, the RUMBD comprising:
a first data structure configured to store a set of general attributes identifying each of a plurality of resource units (RUs) in an IT environment, wherein a RU in the plurality of RUs is a tangible or an intangible entity that provides a measure of workload or efforts required to deliver and support IT services; and
a second data structure separate from the first data structure and configured to store a set of specific attributes corresponding to attributes of each of the plurality of RUs in the first data structure, wherein the first data structure and the second data structure are established to store a set of precise attributes corresponding to each of the plurality of IT resources.

16. The non-transitory computer-readable medium of claim 15, wherein the set of general attributes comprises at least a primary key, a reference of RU name, a total number of RU executed, a total count based on billing entity, a job execution identification, a job execution time, a golden table name from which RUs are calculated, a RU status, or a latest executed result of RU.

17. The non-transitory computer-readable medium of claim 16, wherein the set of specific attributes comprises at least one of a foreign key referring to the primary key, the primary key, names of one or more datasets from which a golden dataset is created after merging, a total count of the one or more datasets from which the golden dataset is created, or complete information of the golden dataset.

18. The non-transitory computer-readable medium of claim 17, wherein the set of specific attributes comprises an identification of each of a set of configuration items (CIs) in configuration management database (CMDB) corresponding to RU.
